(19) United States
(12) Patent Application Publication
(10) Pub. No.: US 2012/0140133 A1
(43) Pub. Date: Jun. 7, 2012

(54) LIQUID CRYSTAL DEVICE COMPRISING CHIRAL NEMATIC LIQUID CRYSTAL MATERIAL IN A HELICAL ARRANGEMENT

(76) Inventors: Su Soek Choi, Cambridge (GB); Flynn Castles, Cambridge (GB); Stephen Morris, Cambridge (GB); Damian Gardiner, Cambridge (GB); Harry Coles, Cambridge (GB)

(21) Appl. No.: 13/322,834

(22) PCT Filed: Jun. 2, 2010
(86) PCT No.: PCT/GB10/50929

§ 371 Date: Feb. 13, 2012

(30) Foreign Application Priority Data
Jun. 2, 2009 (GB) 0909422.8
Oct. 26, 2009 (GB) 0918745.1

(51) Int. Cl. G02F 1/133

(52) U.S. Cl. 349/33

(57) ABSTRACT

This invention generally relates to a liquid crystal device, and more particularly to such a device in the form of a liquid crystal cell such as for a display device, and further relates to a display device having the liquid crystal device, an optical waveguide device comprising the liquid crystal device, a Variable Optical Attenuator comprising the liquid crystal device, an optical switch comprising the liquid crystal device, a method of controlling transmission of polarised light, and to a further liquid crystal device. A liquid crystal device for controlling transmission of polarised light, comprising: chiral nematic liquid crystal having a helical arrangement of liquid crystal molecules in the absence of an electric field; and at least two electrodes for applying an electric field having a component normal to the helical axis of the chiral nematic liquid crystal, wherein the chiral nematic liquid crystal has negative dielectric anisotropy.

### FIELD OF THE INVENTION

This invention generally relates to, inter alia, a liquid crystal device for controlling transmission of polarised light, a display device having a plurality of the liquid crystal devices, an optical waveguide device comprising the liquid crystal device, a variable optical attenuator (VOA) comprising the liquid crystal device, an optical switch or light shutter comprising the liquid crystal device, a laser comprising the liquid crystal device, a method of controlling outputting of light from a liquid crystal device, and a method of controlling transmission of polarised light, and to a further liquid crystal device.

### BACKGROUND TO THE INVENTION

Today, liquid crystals find commercial application in large high definition flat panel television screens. The current state of the art of liquid crystal displays (LCD) involves high definition images with specific refresh rates. The evolution of the LCD is well known and discussed in detail in numerous reports in the literature. Significant advancements in the engineering aspects of the technology, such as the development of active backlighting, have lead to the relatively high performance that is now offered today.

However, current devices are still based on the same generic type of liquid crystals that were used in the pioneering displays. Consequently, limitations in characteristics such as, inter alia, speed, contrast ratio, controllability and large scale uniform alignment of the device still exist.

There is therefore a need for a liquid crystal device, which is improved in respect of at least one of these characteristics. This applies in various fields including display devices and telecommunications.

For use in understanding the present invention, the following disclosures are referred to:
U.S. Pat. No. 5,477,358, Rosenblatt et al, filed Jun. 21, 1993;
U.S. Pat. No. 5,602,662, Rosenblatt et al., filed Feb. 16, 1995;
Physics Letter, Blinov et al, February 1978, vol. 65A, number 1;
B. J. Broughton, M. J. Clarke, A. E. Blatch, H. J. Coles, J. Appl. Phys. 98, 034109 (2005);
“Fast In-Plane Switching Mode in Cholesteric Liquid Crystals”, Barnik and Blinov, EuroDisplay 2007, S5-4
“Electro-optical characteristics of a chiral hybrid in-plane switching liquid crystal mode for high brightness” Jin Seong Gwag et al, Optics Express vol. 16, no. 16, 12226, published Jul. 31, 2008;
European patent EP 1 766 461 B1, Flexoelectro-optic liquid crystal device, Coles H., Coles M., Broughton B., Morris S., applicant Cambridge Enterprise Ltd., related to WO2006003441 published on Dec. 1, 2006;
P. G. de Gennes, The Physics of Liquid Crystals (Oxford University Press, London, 1974, p. 288, 2nd ed.;
S. A. Jewell and J. R. Sambles, Phys. Rev. E, 78, 012701 (2008).
US2003/128305 A1, Isumi Tomoo et al., Minolta, published 2003-07-10;
JP09281484 A, Hisatake Yuzo et al., Toshiba Corp, published 1997-10-31;
Morris, Castles, Broughton, Coles, Proc. SPIE 6587, 658711 (2007); and
Davidson et al, Journal of Applied Physics, Vol. 99, 093109, 2006.

We further refer to the following documents published after the priority date of the present application:
H. H. Lee, J.-S. Yu, J.-H. Kim, S. Yamamoto, and H. Kikuchi, Appl. Phys. Lett. 106, 014503 (2009); and
F. Castles, S. M. Morris, and H. J. Coles, Phys Rev. E. 80, 031709 (2009);
Choi, Castles, Morris, Coles, Appl. Phys. Lett. 95, 193502 (2009);
Castles, Morris, Gardiner, Malik, Coles, J. Soc. Inf. Display 18, 128 (2010); and
Coles, Morris, Choi, Castles, Proc. SPIE 7618, 761814 (2010).

### SUMMARY

The following aspects generally concern embodiments using LC having negative dielectric anisotropy.

According to a first aspect of the invention, there is provided a liquid crystal device for controlling transmission of polarised light, comprising: chiral nematic liquid crystal (LC) having a helical arrangement of liquid crystal molecules in the absence of an electric field; and at least two electrodes for applying an electric field having a component normal to the helical axis of the chiral nematic liquid crystal, wherein the chiral nematic liquid crystal has negative dielectric anisotropy.

More specifically, the rotation of the liquid crystal helical arrangement may due to dielectric coupling of the electric field and liquid crystal. Thus, the coupling may be through the dielectric anisotropy rather than through flexoelectric coefficients. In some embodiments however, the dielectric coupling may be found in combination with flexoelectric coupling. More particularly, flexoelectric coefficients may in some embodiments be optimised, e.g., minimised or maximised, to allow flexoelectric coupling to be used in combination with dielectric coupling. (This paragraph applies to every aspect described herein, including those using negative dielectric anisotropy and those using positive dielectric anisotropy).

Embodiments of the aspect (and any other aspect described herein using LC with negative dielectric anisotropy) may have a combination of at least one or all of short-pitch, uniform standing helix (USH) with negative dielectric anisotropy and in-plane electrodes. Such an embodiment may be used as an intensity modulator between crossed polarisers. All references to short pitch herein may be taken as meaning having pitch shorter, preferably substantially shorter, than the wavelength of the controlled light or, more specifically, shorter than visible wavelengths, i.e., less than 380 nm. The device may have a light source for sourcing the light to be controlled.

Embodiments of such a liquid crystal device may be configured to control transmission of unpolarised or polarised light.

Embodiments may have any/use one or more of the following features: polymer stabilisation of the LC molecular arrangements; dielectric coupling effect to increase a switching effect of the device/method; at least one polariser, the LC preferably disposed between crossed polarisers; the LC being short pitch LC; an optic axis induced by an applied electric field, preferably between crossed polarisers, to give the switching effect; and uniform tilt of the optic axis to be in-plane (e.g., parallel to the plane of the electrodes), preferably between crossed polarisers, to give the switching effect; non-random optic axis when the electric field is applied.

A controlled amount may be a degree/amount of transmission, e.g., a proportion of the light that is passed or attenuated/absorbed by the device. Additionally or alternatively, the control may control the direction of outputting of light from the device. The controlled light may be, for example, circularly or elliptically polarised. This may be determined by the helical structure. The liquid crystal may be a material, e.g., liquid or semi-solid. The helical arrangement may be of molecular orientations, e.g., of long axes of the liquid crystal molecules.

The direction normal to the helical axis of the LC is perpendicular to the axis of the above helical arrangement that exists in the absence of any applied electric field, i.e., the zero-field helical axis.

(The electric field component may be an electric field local to at least a portion (e.g., sub-region) of the LC, for example an electric field in a region of a curved electric field distribution shown in FIG. 1 where the electric field is in-plane; in other scenarios the component may be a resolved vector component of a curved or uniform electric field, the field at least local to the component, the local electric field being non-parallel to the zero-field helical axis).

The LC may be comprised in a composition having a low concentration of reactive mesogen (e.g., Merck RM-257) or polymer. This may be achieved by adding reactive mesogen (which cross-links to form polymer) or polymer to liquid crystals, preferably in a concentration of about 20% w/w or less relative to the LC. Advantages of the polymerised LC are stabilisation of LC molecular arrangements, leading to physical ruggedisation of the LC and/or reduced hysteresis of the device transmission/voltage characteristics. The latter advantage may reduce switching response time. The electric field application may involve applying a voltage such that a potential difference exists between the two electrodes, for example using in-plane electrodes of the device in the form of an in-plane switching device. The polymer, which may by used for LC stabilisation in any one of the aspects described herein (including those using negative dielectric anisotropy and those using positive dielectric anisotropy) may be a diacrylate structure that is photophoymerised using a UV light source with the addition of a low concentration of photoinitiator. This forms a polymer network.

The negative dielectric anisotropy may be obtained by means of a negative dielectric constant, and/or particularly at frequencies used/found in the driving signal for applying the electric field to the electrodes. Speaking more generally, a negative dielectric constant as such is different to a negative dielectric anisotropy, which generally just means the dielectric constant parallel is less than the dielectric constant perpendicular to the director. Further generally, the property of having a negative dielectric anisotropy can vary with frequency. Preferably, the LC composition has a negative dielectric anisotropy at the frequency used in the drive signal.

There may further be provided the above liquid crystal device, configured such that said chiral nematic liquid crystal molecules are helically arranged in the presence of said electric field, the helical axis (of said arrangement in said presence of said field) being aligned to the electric field that exists locally to said molecules. Thus, the helical arrangement is rotated when the electric field is applied between said electrodes, the rotation being reversible. The helical arrangement of LC molecules then existing even in the presence of the electric field is aligned to the orientation of the electric field local to the molecules of that arrangement. Thus, considering the transition from the helical arrangements of molecules before and after application of the electrical field locally to the molecules, a controllable degree of effective rotation of an LC helix may be achieved depending for example on the potential difference applied across the electrodes.

The helical axis thus reorients when an electric field is applied between the electrodes, preferably to lie in the plane of the said electrodes. In the fully aligned state, the liquid crystal (LC) director may lie along the direction of the electrodes, e.g., substantially in the plane of the in-plane switching device. Such a state is an active, transmissive state. More particularly, a state of full alignment of the helical axis to the in-plane electrodes, i.e., in or parallel to the plane of the said electrodes, is preferably an active transmissive state, and/or may be one wherein the helical axis is parallel to the plane of the said electrodes or to the local electric field. The electric field causing reorientation of the helical axis to lie in (e.g., parallel to) the plane of the electrodes may be viewed as causing an effective optic axis to be induced in-plane. Thus, any reference herein to a rotated optic axis may more specifically be described as an induced optic axis, which may be at least partially aligned with the applied electric field.

The electrodes may be, for example, on the same substrate on one side of the LC, and may then generate fringe field(s). Fringe field switching may then occur, for example in a display device comprising electrodes of a plurality of neighbouring LC devices and/or LC elements.

There may further be provided electrodes on an opposite side of the LC. In this case, in-plane electric fields may be created directly from both sides of the LC.

The electrodes may comprise interdigitated electrodes, for example within a layer on one substrate. Such interdigitated electrodes may be formed within, and separated by, an insulating layer on a substrate. Similarly, the electrodes may comprise finger-patterned electrodes on a layer and a plane electrode on another layer separated by an insulating layer on one substrate.

There may further be provided the above liquid crystal device, configured such that an optic axis of the chiral nematic liquid crystal rotates in a plane normal to the local electric field component when the electric field is applied. This may be achievable by the electrodes being arranged appropriately relative to the LC optic axis in the absence of electric field (see FIG. 1). The optical axis of the chiral nematic LC is then preferably oriented in the plane of the electrodes when the electric field is applied. Preferably, the rotation is to align the optic axis to or towards the electric field component. More generally, the plane normal to the local electric field component may be normal to the local direction of the electric field and/or may be perpendicular to the plane of the electrodes.

There may still further be provided the above liquid crystal device, configured to substantially fully align the liquid crystal molecule director in a direction substantially normal to the electric field component when said electric field is applied. This may apply across substantially all of the LC, or may apply to a region of LC to which the electric field component is local. Again, this may be achievable by the electrodes being arranged appropriately relative to the LC optic axis in the absence of e-field (see FIG. 1). The director may be a local director at a point within the helical arrangement of molecules. Preferably, the full alignment of a local liquid crystal molecule director is to a direction substantially normal to the plane of the electrodes.

There may further be provided the above liquid crystal device, wherein said at least two electrodes are configured to apply said electric field substantially fully normal to the helical axis of the chiral nematic liquid crystal, i.e., substantially fully perpendicular to the zero-field helical axis. (In this case, the electric field may be considered to be the electric field component). Thus, there may be substantially no component of the electric field that is not normal to the helical axis. Thus, for a liquid crystal device such as a display cell, the electric field may then be “in-plane”. The above description of “substantially fully normal to the helical axis of the chiral nematic liquid crystal, i.e., substantially fully perpendicular to the zero-field helical axis” may relate to an electric field local to the helical arrangement or to an electric field applied uniformly over the entire LC. The above applying of said electric field of “substantially fully normal” generally relates the moment of applying the field, i.e., the instant before which the helical arrangement responds by rotating.

There may yet further be provided the above liquid crystal device, wherein the helical arrangement has a pitch such that transmission of said polarised light through said chiral nematic liquid crystal (LC) is substantially fully blocked in the absence of said electric field component, e.g., in the complete absence of electric field. Thus, the pitch is short, i.e., shorter than the shortest wavelength of visible light, i.e., less than 380 nm, and the liquid crystal may then be substantially isotropic. Furthermore, the LC may have a hyper-twisted structure. (The pitch may be definable as the distance, parallel to the helical axis, between two points on the helix, where the orientation of the molecules has turned 360 degrees). The liquid crystal may be substantially isotropic as described above for example at normal incidence. In any embodiment, the pitch of the helical arrangement is preferably a short pitch.

(Throughout this specification, any light referred to may be visible light, i.e., in the wavelength range of about 380 nm to about 750 nm including 380 nnm and 750 nm. This may for example apply where the device is the display device, light shutter or laser as described herein. Alternatively, for telecommunications, e.g., wavelength division multiplexing (WDM), applications, the light may be of the order to 1550 nm, e.g., the optical communications C-band (1530 nm to 1565 nm), and/or may cover the optical communications L-band (1565 nm to 1625 nm). The optical waveguide device, variable optical attenuator, optical switch and laser, which are described herein, may be used for telecommunications applications).

There may further be provided the above liquid crystal device, wherein said substantially full blocking blocks at least about 95%, or preferably greater than about 98% or than about 99%, of the polarised light. The blocked transmission is at least transmission parallel to the zero-field helical axis. The device may, for example for display applications, block unpolarised light, for example where the device comprises polariser(s) to block a portion of the light having specific polarisation. (There may be present at least a polariser on the output side of the device, or there may be provided crossed polarisers as further described herein). Blocking of transmission (e.g., of all transmission or of transmission at least parallel to the zero-field helical axis) may similarly be about 95%, or preferably greater than about 98% or than about 99%. In embodiments that block non-polarised and/or polarised light, the degree of blocking may thus be lower at non-normal angles.

There may further be provided the above liquid crystal device, wherein the pitch of the zero-field helical arrangement is less than 380 nm (i.e., shorter than the shortest wavelength of visible light), preferably less than about 260 nm, and more preferably less than about 150 nm (“less than about 260 nm” including 260 nm). However, the specific value of the pitch preferred for a given embodiment may be greater than or less than 380 nm and/or may depend on the LC birefringence. Nevertheless, in any embodiment, the liquid crystal is preferably short pitch liquid crystal.

There may further be provided the above liquid crystal device, wherein the chiral nematic liquid crystal has a thickness (along a direction parallel to the zero-field helical axis) such that said polarised light, which propagates through the LC parallel to the zero-field helical axis, is substantially fully transmitted though said chiral nematic liquid crystal in the presence of said electric field.

There may still further be provided the above liquid crystal device, wherein the device is a liquid crystal cell having a thickness of preferably less than about 20 um, e.g., about 5 um, and more preferably less than about 4.5 um, e.g., 4.3 um.

There may further be provided the above liquid crystal device, configured to be operable by said application of said electric field to have a ratio, e.g., contrast ratio, of transmission of said polarised light in the presence of the electric field to transmission of said polarised light (at least parallel to the zero-field helical axis) in the absence of the electric field of greater than about 1000:1, preferably greater than about 6000:1, preferably at normal incidence. For example, the electrodes may be configured at an appropriate spacing to allow the device to be conveniently driven by a voltage sufficient to fully align the helix to the normal to the zero-field axis. Furthermore, there is preferably no breakdown voltage of the device to prevent such a ratio.

There may further be provided the above liquid crystal device, configured (e.g., at least the electrodes are spaced and/or there is no breakdown voltage as above) to be operable by said application of said electric field to substantially fully align said helical arrangement to an electric field applied normally to the zero-field helical axis (i.e., to allow substantially full transmission of input light) in less than about 50 ms, preferably less than about 1.5 ms, more preferably less than about 1 ms, even more preferably in a time of the order of 100 s of microseconds, starting from a condition where there is no potential difference between the electrodes, i.e., a zero-field condition. Such a time is that during which the electric field is applied and maintained. Such maintenance is preferably to effect the switching to the transmissive state.

There may yet further be provided the above liquid crystal device, configured (e.g., at least the electrodes are spaced and/or there is no breakdown voltage as above) to be operable by said removal of said applied electric field to substantially fully recover alignment of said helical arrangement in less than about 50 ms, preferably less than about 100 us, starting from the transmissive state wherein the helical arrangement is substantially fully aligned to an electric field applied normally to the zero-field helical axis.

There may yet further be provided the above liquid crystal device, further comprising: at least two polarisers each having a polarisation axis, wherein said two polarisers are crossed polarisers; and said chiral nematic liquid crystal is disposed between said crossed polarisers. For crossed polarisers, an angle between the polarisation axes of the polarisers may be non-zero, i.e., the axes are non-aligned, preferably the angle being substantially 90 degrees. (Alternatively, the polarisers may be at an angle of about 45 degrees). The planes of the polarisers themselves are preferably substantially parallel. Such a device may further comprise a substrate, e.g. silicon, on which a said crossed polariser is disposed. For example, one polariser may be on the substrate if the cell has a stacked structure and there are only two polarisers.

There may further be provided the above liquid crystal device, wherein an optic axis at each surface of said chiral nematic liquid crystal adjacent a said polariser is at an angle of substantially 45 degrees to the polarisation axis of each said crossed polariser.

There may further be provided the above liquid crystal device, wherein the liquid crystal comprises a chiral dopant such as BDH1281.

There may further be provided the above liquid crystal device, further comprising inner substrates having unidirectionally rubbed polyimide alignment layers. This may be particularly advantageous for achieving both a standing helix in the absence of a field and/or a planar-aligned nematic in the field ‘on’ state or in the field ‘on’ state. Preferably the device comprises USH (Uniform Standing Helix) liquid crystal.

There may further be provided the above liquid crystal device, further comprising a compensation plate, e.g., optical compensation film. Such a plate may diffuse and/or phase retard light to widen the light output angle, e.g., viewing angle where the device is used for display. The plate may—additionally or alternatively to being a compensation plate—be a diffusing plate. The diffusing and/or compensation plate may diffuse and/or phase retard light. Preferably, the range of viewing angles over which the image will be of good quality is increased by use of such a plate, even in embodiments where the light comes out at substantially all angles, e.g., over a full 180 degrees from a planar output surface of the device.

There may further be provided the liquid crystal device, wherein the chiral nematic liquid crystal comprises dye such as dichroic dye, pleochroic fluorescent dye and/or a plurality of different coloured dyes. (The colours of the different coloured dyes may be red, yellow and blue, for example). The dye may be absorptive or fluorescent dye. A dye-guest effect may then be observed wherein the dye molecules reorientate with the above helix rotation, so that the dye effect is effectively switched on/off with the application of the electric field. In such an embodiment, there may be less advantage to providing input and/or output polarisers.

As described above, there may further be provided the liquid crystal device, having a composition comprising said chiral nematic liquid crystal and polymer.

There may further be provided the liquid crystal device, comprising at least one reflector, wherein said at least one reflector is preferably metallic, dielectric (e.g. a dielectric mirror), coloured, absorbing and/or fluorescent. (Coloured and absorbing reflectors selectively reflect colours/wavelengths). This may be advantageous where the light to be controlled is received on one side of the LC and reflected to be output from the same side, e.g., where the light is ambient light such as sunlight.

According to a second aspect of the invention, there is provided a display device, e.g. comprising a plurality of the above liquid crystal devices. Such a display device may be, for example, an LCD display (preferably flat-panel) for a monitor, mobile phone, computer, television, etc.

According to a third aspect of the invention, there is provided an optical waveguide device comprising the above liquid crystal devices. Such a waveguide device may be used for, e.g., optical computing, telecommunications or laser applications, e.g., a fibre-to-fibre interconnect.

According to a fourth aspect of the invention, there is provided a variable optical attenuator (VOA) comprising the above liquid crystal device. Such a VOA may be an optical attenuator operable by application of the electric field to control a degree of attenuation of polarised light, e.g., for amplitude modulation or equalisation of an optical telecommunications signal.

According to a further aspect of the invention, there is provided a laser comprising the liquid crystal device, wherein the chiral nematic liquid crystal comprises, e.g., is doped with, a light harvester such as laser dye (which may be added in solution, e.g., as a solution including laser dye molecules), fluorescent dye and/or quantum dots. The dye may be attached to liquid crystal molecules, e.g. the light harvester may also comprise mesogenic moieties, chemically or synthetically attached to the light harvesting moiety, to promote solubility and ordering of the light harvesting moiety within the liquid crystal host.

According to a further aspect of the invention, there is provided an optical switch, e.g., for use in a WDM system for blocking or passing WDM channels or single wavelength signals, or light shutter, comprising the above liquid crystal device.

According to a further aspect of the invention, there is provided a method of controlling outputting of light from a liquid crystal device, comprising: applying an electric field to a helical arrangement of liquid crystal molecules of chiral nematic liquid crystal of said device; and said helical arrangement rotating to align the helical axis of the arrangement to said electric field, wherein said chiral nematic liquid crystal has negative dielectric anisotropy and said helical arrangement has helical pitch of less than 380 nm. The method may further comprise removing said electric field to return the helical axis orientation to the orientation that existed before said applying said electric field. The device may further comprise at least one polariser, e.g., the helical arrangement of liquid crystal molecules may be provided between crossed polarisers.

According to a further aspect of the invention, there is provided a method of controlling transmission of polarised light, comprising: applying an electric field across chiral nematic liquid crystal disposed between crossed polarisers, wherein the liquid crystal has negative dielectric anisotropy and a helical arrangement of liquid crystal molecules in the absence of an electric field, wherein said electric field has a component normal to the helical axis of the chiral nematic liquid crystal, i.e., normal to the zero-field helical axis. (However, such a method may be performed wherein no, or merely a single, polariser is present). In an embodiment, such a method may control transmission of unpolarised light.

There may further be provided the above method, wherein the pitch of said helical arrangement is less than 380 nm, preferably less than about 260 nm, more preferably less than about 150 nm. Thus, the pitch of the helical arrangement is again shorter than the shortest wavelength of visible light. However, as above, the specific value of the pitch preferred for a given embodiment may be greater than or less than 380 nm and/or may depend on the LC birefringence. Nevertheless, in any embodiment, the liquid crystal is preferably short pitch liquid crystal.

There may further be provided the above method, wherein the electric field is applied such that the liquid crystal molecules have a helical arrangement, the helical axis of which is aligned to said electric field when the electric field is applied and preferably maintained. Thus, a helical arrangement is retained and the helical axis rotates towards alignment with the applied electric field to put the device in a transmissive state, the electric field being local to the rotated helical arrangements of molecules. Preferably, the electric field is applied such that the optical axis of the chiral nematic LC aligns to be in the plane of the electrodes and parallel to the electric field. More specifically, the electric field is applied such that the optical axis of the chiral nematic LC aligns to be substantially parallel to the plane of the electrodes and/or substantially parallel to the electric field.

There may further be provided the above method, wherein the electric field is applied such that an optic axis of the chiral nematic liquid crystal rotates normal to the electric field component. In such a case, the applied electric field is the electric field component, i.e., is fully normal local to the zero-field helical axis. Preferably, the rotation is to align the optic axis to or towards the electric field component. More generally, the plane normal to the local electric field component may be normal to the local direction of the electric field and/or may be perpendicular to the plane of the electrodes.

There may further be provided the above method, wherein the electric field is applied substantially fully normal to the helical axis of the helical arrangement.

There may further be provided the above method, comprising applying said electric field component continuously throughout a time period of less than about 50 ms, preferably equal to or less than about 1.5 ms, more preferably equal to or less than about 1 ms, to substantially fully align said helical arrangement to said electric field, preferably starting from a zero-field condition.

There may further be provided the above method, comprising removing said electric field component continuously throughout a time period of less than about 50 ms, preferably equal to or less than about 100 us, more preferably equal to or less than about 35 us, to substantially fully recover alignment of said helical arrangement, preferably starting from the transmissive state wherein the helical arrangement is substantially fully aligned to an electric field applied normally to the zero-field helical axis. The recovered alignment is to a direction of the zero-field helical axis. When fully recovered, the LC may have returned to the helical structure that it would have in the permanent absence of an electric field.

There may further be provided the above method, comprising said applying of said electric field according to a predetermined transmission greyscale. Thus, the strength of the electric field may be continuously varied to achieve analogue variation of degree of transmission between fully dark and fully transmissive states.

According to an arrangement, there is provided a liquid crystal device for controlling transmission of polarised light, comprising: chiral nematic liquid crystal having a helical arrangement of liquid crystal molecules in the absence of an electric field; and at least two electrodes for applying an electric field having a component normal to the helical axis of the chiral nematic liquid crystal, wherein the chiral nematic liquid crystal has a negative dielectric constant such that an optic axis of the chiral nematic liquid crystal rotates in a plane normal to the electric field component when the electric field is applied. Preferably, the optic axis of the chiral nematic liquid crystal rotates to align to the electric field component when the electric field is applied. (Other, similar arrangements may differ in that the LC has negative dielectric anisotropy additionally or alternatively to the negative dielectric constant).

According to a further aspect of the invention, there is provided a liquid crystal device for controlling transmission of light, comprising: a light source to emit said light; chiral nematic liquid crystal having a helical arrangement of liquid crystal molecules in the absence of an electric field; and at least two electrodes for applying an electric field having a component normal to the helical axis of the chiral nematic liquid crystal, wherein the chiral nematic liquid crystal has negative dielectric anisotropy and is liquid crystal having pitch shorter than a shortest wavelength of said light. Preferably, the LC is USH (generally, USH is an arrangement in the absence of the electric field), the device electrodes are in-plane electrodes, and/or the device can be used as an intensity modulator between crossed polarisers. The controlled light may be polarised or unpolarised light.

The following aspects generally concern embodiments using LC having positive dielectric anisotropy. (As for the aspects using negative dielectric anisotropy, all references to short pitch may be taken as meaning having pitch shorter, preferably substantially shorter, than the wavelength of the controlled light or, more specifically, shorter than visible wavelengths, i.e., less than 380 nm. The device may have a light source for sourcing the light to be controlled. The device may be for controlling polarised and/or unpolarised light).

According to a first such aspect of the invention, there is provided a liquid crystal device for controlling outputting of light from said device, the device comprising: chiral nematic liquid crystal having a helical arrangement of liquid crystal molecules and having positive dielectric anisotropy; at least two electrodes for applying an electric field having a component normal to the helical axis of the chiral nematic liquid crystal molecules, the chiral nematic preferably having pitch shorter than a shortest wavelength of said light; the liquid crystal such that the helical arrangement of molecules rotates towards alignment with the electric field, preferably to align with the local electric field, wherein the liquid crystal is provided in a composition further comprising polymer. Provision of the polymer is to advantageously stabilise the helical arrangement of the liquid crystal, an advantage thereof being to reduce a switching time of the device. The polymer may be in the form of monoacrylate or diacrylate. Preferably, the helical arrangement in the absence of the electric field comprises a standing helical arrangement, i.e., is not ULH (Uniform Lying Helix), e.g., may be USH (Uniform Standing Helix). The light may or may not be polarised.

The following relates to optional features of this aspect (and of the other aspects generally concerning embodiments using LC having positive dielectric anisotropy as described further below). These preferred features correspond closely to preferred features of the above aspects generally concerning embodiments using LC having negative dielectric anisotropy. Thus, the more detailed descriptions provided above further apply generally to the aspects concerning embodiments using LC having positive dielectric anisotropy. Firstly, the chiral nematic liquid crystal molecules may be helically arranged in the presence of said electric field, a helical axis of said arrangement in said presence of said field being aligned to said electric field applied to said molecules. The liquid crystal helical arrangement may be to dielectrically couple to the electric field to rotate the helical axis of said helical arrangement in a direction dependent on the direction of the electric field. The device may be configured such that an optic axis of the chiral nematic liquid crystal rotates in a plane normal to the electric field component when the electric field is applied, the rotation preferably to align the optic axis to the electric field. The at least two electrodes may be configured to apply said electric field substantially fully normal to the helical axis of the chiral nematic liquid crystal. The helical arrangement may have a pitch such that transmission of said light through said chiral nematic liquid crystal is substantially fully blocked in the absence of said electric field component, preferably to block at least about 95% of the light. The LC may be less than 380 nm, preferably less than about 260 nm, more preferably less than about 150 nm. The chiral nematic liquid crystal may have a thickness such that said light is substantially fully transmitted though said chiral nematic liquid crystal in the presence of said electric field. The device may be configured to be operable by said application of said electric field to have a ratio of transmission of said light in the presence of the electric field to transmission of said light in the absence of the electric field of greater than about 1000:1, preferably greater than about 6000:1. The device may be operable by said application of said electric field to substantially fully align said helical arrangement to said electric field component in less than about 50 ms, preferably less than about 1 ms. The device may be configured to be operable by removal of said applied electric field to substantially fully recover alignment of said helical arrangement in less than about 50 ms, preferably less than about 100 us. The device may further comprise: at least two polarisers each having a polarisation axis, wherein said two polarisers are crossed polarisers; and said chiral nematic liquid crystal is disposed between said crossed polarisers. The liquid crystal may be comprised in a composition having polymer for stabilisation of molecular arrangements of the liquid crystal, preferably to reduce a switching response time of the device. The polymer may be in the form of monoacrylate or diacrylate The chiral nematic liquid crystal may comprise dye such as dichroic dye, pleochroic fluorescent dye and/or a plurality of different coloured dyes. The device may have the chiral nematic liquid crystal comprised in a composition further comprising polymer. The device may comprise at least one reflector, wherein said at least one reflector is preferably metallic, dielectric, colour, absorbing and/or fluorescent. The at least two electrodes may be in a substantially common plane.

There may further be optionally provided a display device comprising a plurality of the liquid crystal devices, an optical waveguide device comprising the liquid crystal device, a variable optical attenuator comprising the liquid crystal device, an optical switch comprising the liquid crystal device, a light shutter comprising the liquid crystal device, or a laser comprising the liquid crystal device wherein the chiral nematic liquid crystal comprises light harvester such as laser dye, fluorescent dye and/or quantum dots. In each case, the device may be of any one of the device aspects using positive dielectric anisotropy as described herein.

According to a second such aspect of the invention, i.e., using positive dielectric anisotropy, there is provided a method of controlling output of light from a liquid crystal device, the device comprising chiral nematic liquid crystal having a helical arrangement of liquid crystal molecules and having positive dielectric anisotropy and further comprising at least two electrodes for applying an electric field normal to the helical axis of the chiral nematic liquid crystal molecules, the liquid crystal provided in a composition further comprising polymer, the method comprising: applying the electric field; and rotating the helical arrangement towards alignment with the electric field, preferably to align with the electric field. Preferably, the helical arrangement in the absence of the electric field is not ULH, e.g., may be USH. The above optional features of aspects generally concerning embodiments using LC having positive dielectric anisotropy may be implemented correspondingly in this aspect.

According to a still further such aspect of the invention, which may be implemented in a method according to the above “second such aspect” and the optional features thereof, there is provided a method of controlling output of light from a liquid crystal device, the device comprising chiral nematic liquid crystal having a helical arrangement of liquid crystal molecules and having positive dielectric anisotropy and further comprising at least two electrodes for applying an electric field normal to the helical axis of the chiral nematic liquid crystal molecules, wherein: in the absence of the electric field, the orientation of the helical arrangement and optic axis of the chiral liquid crystal is such that the polarisation state of any linearly polarised light incident on the device is perpendicular to the optic axis and helical arrangement, and the liquid crystal is comprised in a composition having polymer, the polymer preferably being to a concentration of between about 0.1% and about 30% w/w in the host chiral liquid crystal, the method comprising: applying the electric field to rotate the helical arrangement and optical axis of the chiral nematic liquid crystal to align, or partially align, to a plane defined by the electrodes; and after removal of the electric field, the optical axis and helical arrangement relax back to the state before the electric field was applied. As mentioned above, in the absence of the electric field, the orientation of the helical arrangement and optic axis of the chiral liquid crystal is such that the polarisation state of any linearly polarised light incident on the device is perpendicular to the optic axis and helical arrangement, i.e., the method preferably does not use a ULH LC device, e.g., may use a USH LC device. The alignment, or partial alignment, to a plane defined by the electrodes may be to a plane substantially parallel to the plane of the electrodes.

According to a yet further such aspect of the invention, which may be provided in a device according to the above “first such aspect” and the optional features thereof, there is provided a liquid crystal device for controlling output of light from the device, the device comprising chiral nematic liquid crystal having a helical arrangement of liquid crystal molecules and having positive dielectric anisotropy and further comprising at least two electrodes for applying an electric field normal to the helical axis of the chiral nematic liquid crystal molecules, the device comprising: the liquid crystal such that, in the absence of the electric field, the orientation of the helical arrangement and optic axis of the chiral liquid crystal is such that the polarisation state of any linearly polarised light incident on the device is perpendicular to the optic axis and helical arrangement, and the liquid crystal comprised in a composition having polymer, the preferably polymer being to a concentration of between about 0.1% and about 30% w/w in the host chiral liquid crystal; the liquid crystal such that application of the electric field rotates the helical arrangement and optical axis of the chiral nematic liquid crystal to align, or partially align, to a plane defined by the electrodes; the liquid crystal such that, after removal of the electric field, the optical axis and helical arrangement relax back to the state before the electric field was applied. The alignment, or partial alignment, to a plane defined by the electrodes may be to a plane substantially parallel to the plane of the electrodes.

According to a still further such aspect of the invention, which may be implemented in a method according to the above “second such aspect” and the optional features thereof, there is provided a method of controlling output of light from a liquid crystal device, the device comprising chiral nematic liquid crystal having a helical arrangement of liquid crystal molecules and having positive dielectric anisotropy and further comprising at least two electrodes for applying an electric field normal to the helical axis of the chiral nematic liquid crystal molecules, the method comprising: applying the electric field to rotate the helical arrangement and optical axis of the chiral nematic liquid crystal to align, or partially align, in a plane defined by the electrodes; after removal of the electric field, the optical axis and helical arrangement remaining aligned, or partially aligned, in the plane defined by the electrodes; and at least one further electrode applying a further electric field the at least one further electrode oriented to apply said further electric field substantially normal to the rotated axis of the helical arrangement and rotated optical axis. The rotated optical axis may be described as an induced optical axis. As mentioned above, the liquid crystal is such that, in the absence of the electric field, the orientation of the helical arrangement and optic axis of the chiral liquid crystal is such that the polarisation state of any linearly polarised light incident on the device is perpendicular to the optic axis and helical arrangement, i.e., the method preferably does not use a ULH LC device, e.g., may use a USH LC device. The alignment, or partial alignment, to a plane defined by the electrodes may be to a plane substantially parallel to the plane of the electrodes.

Preferred embodiments are defined in the appended dependent claims.

### BRIEF DESCRIPTION OF THE DRAWINGS

For a better understanding of the invention and to show how the same may be carried into effect, reference will now be made, by way of example, to the accompanying drawings, in which:

FIG. 1 shows a schematic of a device according to an embodiment, including an illustration of the principle of operation;

FIG. 2a shows experimental results of the transmission of the device as a function of the applied electric field;

FIG. 2b shows the optical response demonstrating the rise and decay times of the device;

FIG. 3 shows photographs of a cell of the device mounted on a light box for different electric field strengths;

FIG. 4a shows isocontrast curves for the device with a compensation plate;

FIG. 4b shows isocontrast curves for the device without a compensation plate;

FIGS. 5a-c show CIE diagrams of the device;

FIG. 5d shows a colour contour plot for the device;

FIG. 6 shows photomicrographs of N*LC of another embodiment that has a structure as in FIG. 1;

FIG. 7 shows electro-optic characteristics of the other embodiment;

FIG. 8 shows the data for the all-electrical induced ULH device versus conventional (manual) induction;

FIG. 9 shows a schematic of the ULH device;

FIG. 10 shows a transmission-voltage characteristic of a polymer stabilized short-pitch LC device; and

FIG. 11 shows an arrangement wherein short pitch helical liquid crystal unwinds as further described herein.

### DETAILED DESCRIPTION OF PREFERRED EMBODIMENTS

The evolution of the liquid-crystal display is well known and discussed in detail in numerous reports in the literature. There is currently a strong drive towards faster-response, high contrast, display modes, capable of incorporating Field-Sequential Colour generation. Such devices will have a number of considerable benefits, such as higher resolution and lower power consumption, since no colour filter is required. A device that retains the favourable properties of existing displays, yet has a fast response time, is therefore of considerable interest. Alternative fast-switch LC technologies such as ferroelectric and uniform-lying helix flexoelectric LCs are difficult to align uniformly over large areas.

Chiral nematic displays may use conventional electrodes or in-plane electrodes. Such devices will typically be based on the effect of selective reflection within the range of operational wavelengths. Such devices may be generated using short-pitch chiral nematics, such that the range of selective reflection lies below the range of operational wavelengths. The chiral nematic may be aligned with the helical axis perpendicular to the plane of the device: variously called the ‘standing-helix’, ‘planar aligned’, or ‘Grandjean’ configuration. For sufficiently short pitch, the structure is effectively optically isotropic at normal incidence, leading to a dark state between crossed polarisers. For the application of fringe fields to a positive chiral nematic LC, focal conic defects above the electrode areas may occur due to the non-uniform electric field distribution close to the electrodes.

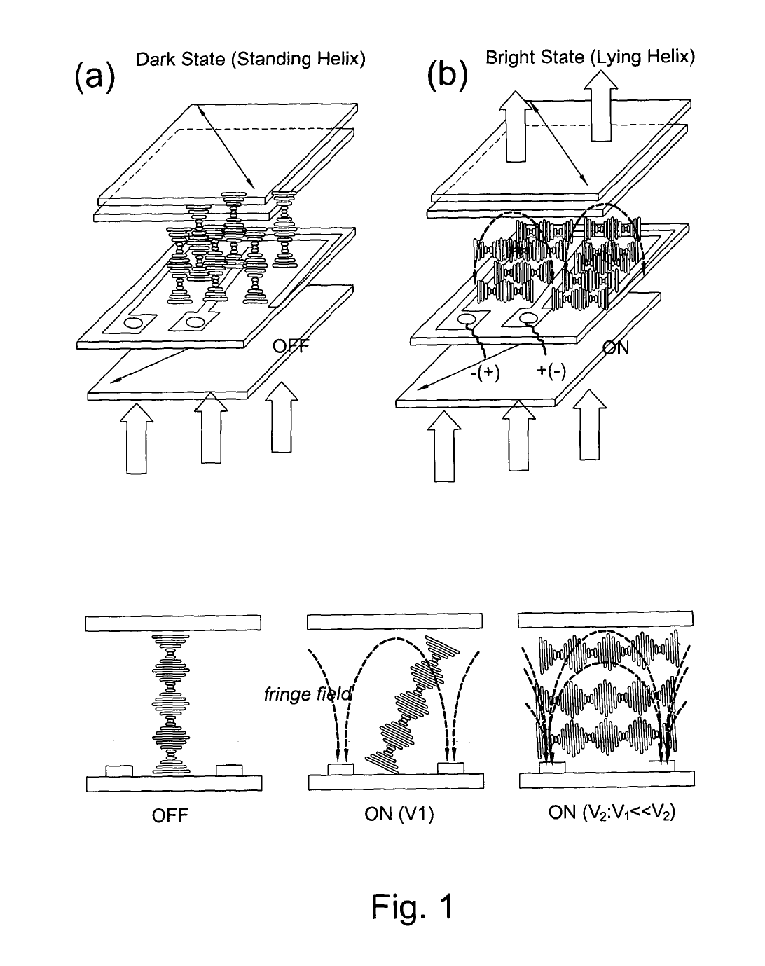

We describe the operation of a device embodiment using a negative dielectric chiral nematic LC and in-plane electrodes. In this case, the switching mechanism is found to be new and disruption of the texture near the electrodes is minimised. The helical structure is found to switch between a standing-helix and lying-helix configuration, as shown schematically in FIG. 1. The effect may be understood in terms of the dielectric response of the LC.

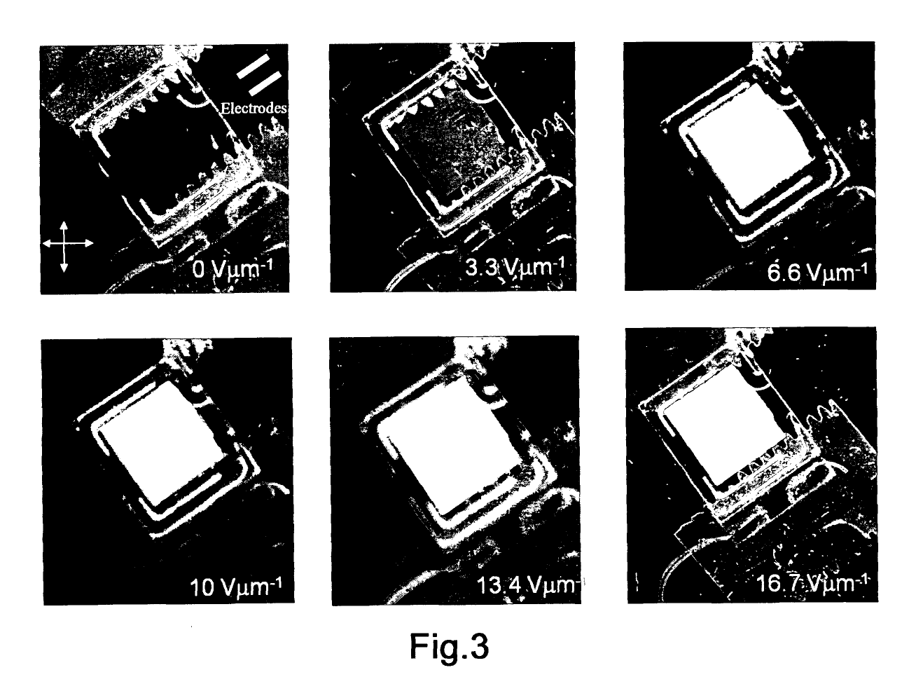

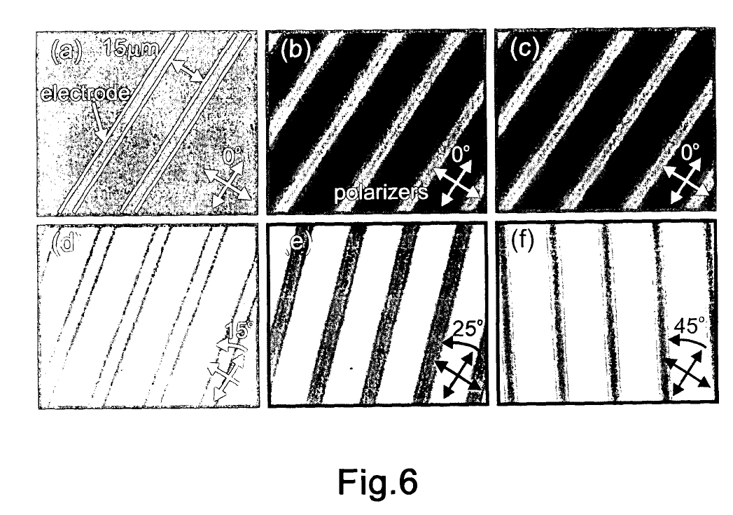

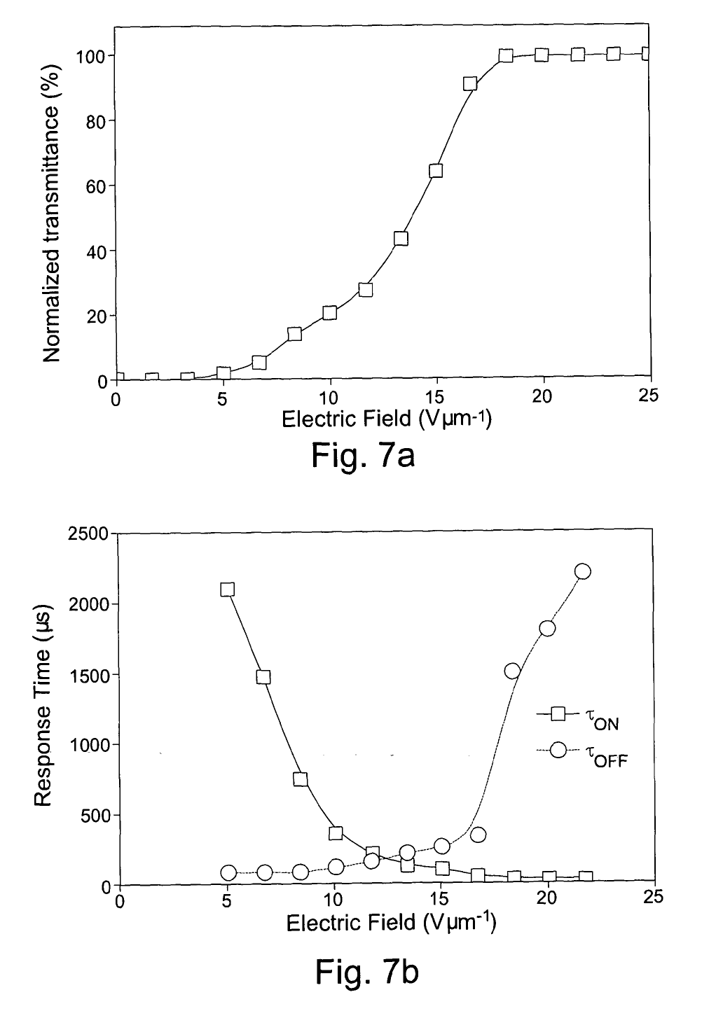

To illustrate the device embodiment and characteristics, FIG. 1 shows a schematic of the operating principle of the device: (a) with no field applied the chiral nematic liquid crystal is optically isotropic between crossed polarisers and the device is ‘off’; and (b) an applied, in-plane, electric field causes the helical axis to lie in the plane of the device, resulting in a transmissive, ‘on’ state. FIG. 6 shows photomicrographs of the N*LC with a negative dielectric anisotropy and pitch 370 nm with: (a) no field applied, and under the application of an in-plane electric field of 400 Vₚₚ and frequency; and (b) 30 Hz, (c) 1 kHz, (d) 1 kHz with 15° cell rotation, (e) 1 kHz with 25° cell rotation and (f) 1 kHz with 45° cell rotation. FIG. 3 shows photographs of the 4.3 micron cell between crossed polarisers on a light box, for six different electric field strengths. The electro-optic cells are approximately 1 cm×1 cm in dimensions and the polarisers cover the whole field of view. Crossed polarisers are aligned at 45° to the in-plane electrodes. FIG. 7 shows electro-optic characteristics of the device at 1 kHz between crossed polarisers. (a) Transmission-voltage profile. (b) 10-90% switch-on and 90-10% switch-off response times. The N*LC of FIG. 6 may be described as cholesteric/chiral nematic liquid crystal (note: cholesteric and chiral nematic can be used interchangeably).

In the absence of an electric field the helix is aligned perpendicular to the plane of the substrates with the alignment of the molecules at the surfaces oriented at 45° to the transmission axes of the polariser and analyser (FIG. 1a). In this case, the device appears black between crossed-polarisers. Upon application of an electric field, the free energy of a chiral nematic with negative dielectric anisotropy is minimised when the helical axis is aligned along the electric field. Hence, for an in-plane field, the chiral nematic tends to switch to the lying-helix configuration. This effect is confirmed by fluorescence confocal imagery in a long-pitch system (˜5 μm). In the in-plane position, the birefringence of the LC will cause light to be transmitted. This will be optimised under the half-waveplate condition 2d|Δn_{eff}|=λ, where d is the thickness of the LC layer, Δn_{eff} is the effective (negative) birefringence of the chiral nematic, and λ is the wavelength of light.

Samples were prepared by mixing a low concentration by weight of a high twisting power chiral dopant (BDH1305, Merck KGaA, helical twisting power 60 μm⁻¹) into a nematic liquid crystal with a negative dielectric anisotropy (Δ∈˜−4) and birefringence of Δn˜0.07 (in-house mixture), using a precision balance (Mettler Toledo). The sample was placed in a bake oven at a temperature of 100° C. for a period of 24 hours to ensure sufficient mixing of the constituents via thermal diffusion. The resultant mixture was capillary filled into a d=4.3 μm spaced cell which had unidirectionally rubbed polyimide alignment layers on the inner substrates in order to achieve a standing-helix in the absence of a field. To apply an electric field to the sample perpendicular to the helix axis, indium tin oxide (ITO) was coated onto the surfaces using photolithography to provide inter-digitated electrodes (FIG. 1). The electrode spacing and width was 15 μm and 5 μm, respectively.

(Generally, the choice of dopant, e.g., BDH1305 or BDH1281, is a practical matter, e.g., for solubility in the specific LC host etc. Thus, a selected dopant may provide twisted or hyper-twisted LC. For experiments which may rely on an optically neutral to optically active switch (such as negative dielectric anisotropy embodiments described herein, as well as positive dielectric-anisotropy-with-polymer system embodiments described later in this specification) they can be described as highly twisted, since this may be advantageous for the layer to be optically neutral to visible light wavelengths at zero field. For example in an experiment where the helical axis was induced to be in-plane and then to be addressed by a third electrode, it was not a stipulation that the system was as highly twisted).

All measurements were carried out at a constant temperature of 25° C. A uniform alignment of chiral nematic liquid crystal was confirmed using an optical polarising microscope (BH-2, Olympus). An electric field was applied using a signal generator (TG1304, Thurlby Thandar) and a high voltage amplifier (built in-house). Transmission-voltage curves and the optical response were captured using a photodiode mounted in the phototube of the microscope and connected to a digitising oscilloscope. Photographs of the cells were captured using a Cannon Ixus-700 camera and a white light source (OSL1-EC illuminator, Thorlab Inc). Spectra were measured using a USB2000 spectrometer (Ocean Optics).

Photomicrographs, shown in FIG. 6, indicate that a lying-helix configuration is indeed obtained in the system. Further, the cell is seen to be free of disruptive defect structures. For clarity, a pitch of 370 nm is initially used, which has a considerable amount of transmittance in the field-off state (FIG. 6a). This allowed for a comparison between the regions above, and in-between, the electrodes as the angle of the LC was rotated with respect to crossed polarisers. Under the application of an electric field, a uniform texture is observed between the electrodes (FIG. 6b-f). Above the electrodes, the standing-helix structure is seen to remain largely unchanged. With the polarisers aligned parallel and perpendicular to the direction of the in-plane field, the region between the electrodes is observed to be non-transmissive (FIG. 6b-c). As the relative angle of the polarisers is rotated, a characteristic lying-helix texture was identified (FIG. 6d-e). At a relative angle of 45°, the transmission from the region between the electrodes is maximised (FIG. 6f). During both the ‘on’ and ‘off’ switching processes the optical response of the device occurs without disruption to the texture in the form of focal conic domains or oily streaks. Additionally, transmission spectra showed that the photonic band gap of the chiral nematic was blue-shifted upon application of an electric field. This provides further evidence that the helical axis is rotated to an in-plane configuration, and not unwound.

The operation of the device is demonstrated in FIG. 3. for a pitch of 260 nm. Photographs of the test-cell between crossed polarisers, and mounted on a light box, are presented for different electric field strengths. In the absence of an electric field, the cell is optically black, and there is no discernible difference between the cell and the background regions of only crossed polarisers. As the field strength is increased, the transmission increases in a controlled, smooth, way.

The measured transmission of the device, as a function of the applied electric field, is shown in FIG. 7a. The change in transmittance through the device increases as the strength of the field is increased, with a threshold at approximately 5 V μm⁻¹. At ≈18 V μm⁻¹ the transmittance saturates. The response time of the switching mechanism upon application and removal of the electric field is shown in FIG. 7b. The switch-on and switch-off times, τₒₙ and τ_{off}, were measured from the 10-90% and 90-10% transmission levels respectively. At full-intensity modulation (18.3 V μm⁻¹), it was found that τₒₙ=0.035 ms, and τ_{off}=1.5 ms. The mid-range grey-level to grey-level response is of the order ˜0.1 ms.

The contrast ratio of the device was found by measuring the ratio of the luminance in the field-on transmissive state (lying helix), to that in the field-off ‘dark’ state (standing helix). The luminance was determined from the transmitted spectra by integrating the intensity as a function of wavelength from 380 nm to 780 nm, weighted by the standard colour matching function of the green component of light [E. Lueder, Liquid Crystal Displays: Addressing Schemes and Electro-Optical Effects (Wiley, 2001), p. 137; J. Schanda, Colorimetry: Understanding the CIE System, (Wiley, Hoboken, 2007)]. The experimental contrast ratio was found to be CR=952:1 without any optical compensation film or back light intensity control. For comparison, if the ‘off’ state was considered to simply be the crossed polarisers themselves (with no LC present), the contrast ratio is CRₘₐₓ=1043:1. This indicates that the dark state of the device is close to the darkest possible state achievable in our experimental system. The CR may be expected to be considerably higher if higher-quality polarisers were used, and/or the half-waveplate condition were optimised. Using the theoretical Berreman method [D. W. Berreman, J. Opt. Soc. Am. 62, 502, (1972).], a CR of 3200:1 is predicted using the typical device parameters of: pitch P=263 nm, thickness 4.3 μm, and an optimised birefringence≈0.064. The transmitted intensity in the ‘off’ state depends strongly on the pitch (approximately P⁶), therefore a shorter pitch can lead to a contrast ratio that is considerably higher still.

Thus, the embodiment provides a liquid crystal display mode with response time ≦1.5 ms, and a contrast ratio of ≈1000:1. Further development of the materials and improvements to the device architecture, so as make Δ∈ values more strongly negative, and to ensure maximum field strength at the sample, will help to reduce the applied voltage required for switching. The results show that this switching mode has considerable potential for fast light shutters and flat-panel display modes.

Generally speaking, the foregoing paragraphs starting under the ‘Detailed Description’ heading relate to a preferably high contrast chiral nematic liquid crystal device using negative dielectric material. The described liquid crystal device embodiment was demonstrated using a short-pitch (260 nm) chiral nematic with negative dielectric anisotropy. Due to dielectric coupling, an in-plane electric field switched the liquid crystal between the standing-helix (field-off, ‘dark’ state) and lying-helix (field-on, transmissive state) configurations. The said foregoing paragraphs thus, again generally speaking, relate to experimental results on the optical transmission as a function of the applied field, the response time (less than 1.5 ms), and the contrast ratio (1000:1).

The following describes an embodiment of a liquid crystal device in the form of a liquid crystal cell. The device may advantageously be used to provide a high contrast liquid crystal display mode with, for example, a 100 microsecond response time. It may be particularly applicable to high definition flat panel television screens, for example as large as 100 inches.

A switching mode of the embodiment is based upon a chiral nematic liquid crystal that has a negative dielectric anisotropy, in-plane electrodes, and a hyper-twisted structure. (‘In-plane’ generally means parallel to a plane defined by a substrate and/or polarisers of the device). In the absence of an electric field the LC appears optically black between crossed polariser as a result of the very short pitch (˜150 nm) of the helical structure. The short-pitch has further ramifications in that the time for the LC to relax to the field-off state is very fast (of the order of, or less than, ms). Theoretical and experimental results show very high contrast combined with greyscale controllability.

The embodiment is applicable to liquid crystal displays (LCD), which involve high definition images with refresh rates above 100 Hz. In particular, the response time of the LC component of the embodiment may be substantially unrestricted by the intrinsic visco-elastic driven relaxation of nematic LC.

Alternative LC technologies such as ferroelectric and flexoelectric are available. However, these LCs may be difficult in achieving large scale uniform alignment. Flexoelectro-optic switching in chiral nematics when aligned in a uniform lying helix configuration, which may give rise to a fast-in plane rotation of the optic axis (for example in combination with dieletric coupling), may also suffer from a similar problem in terms of uniform alignment.

By rotating the geometry of the helix axis to align perpendicular to the substrates, and with the application of an in-plane electric field, a fast-modulating polarisation controller may be constructed provided the pitch of the helical structure was considerably less than the wavelength of the incident radiation. The combination of an in-plane electric field and a standing helix geometry may result in a fast out-of-plane rotation of the optic axis as a result of a deformation of the helix due to dielectric and/or flexoelectric coupling. In the field ‘off’ state the chiral nematic device is optically isotropic between crossed polarisers and no light is transmitted. However, when the optic axis tilts out-of-plane due to dielectric and/or flexoelectric coupling a birefringence is induced and the device becomes optically active between crossed polarisers. In the first instance such a controller may be applicable for telecommunication applications whereby the wavelength of the incident radiation is of the order of 1550 nm, and this liquid crystal mode may further be applicable for a display application. For the development of such a display mode based upon dielectric and/or flexoelectric switching, compounds which possess large dielectric and/or flexoelectric coefficients may be advantageous. Bimesogenic materials may meet these criteria. (All aforementioned references in this paragraph to dielectric and/or flexoelectric coupling refer generally to coupling with the applied field, preferably to dielectric coupling, which may optionally be combined with flexoelectric coupling though more preferably flexoelectric coefficients are minimised).

Nevertheless, even without flexoelectric switching, the high extinction of a hyper-twisted chiral nematic between crossed polarisers is of significant interest, especially for in-plane switching devices. In this regard, the above embodiment may allow a fast-switching mode based upon a negative dielectric anisotropy chiral nematic and in-plane electrodes coated onto the inner surface of one of the substrates. Experimental results are presented on the transmittance and response of the device, and theoretical results are presented on the iso-contrast curves and/or the contrast ratio.

Samples were prepared by dispersing a low concentration by weight of a high twisting power chiral dopant (BDH1281, Merck KGaA) into a nematic liquid crystal with a negative dielectric anisotropy (Merck KGaA). These compounds were used as received and no further purification was carried out. After mixing on a precision balance (Mettler Toledo), the sample was then placed in a bake oven for a period of 24 hours to ensure sufficient mixing of the constituents via thermal diffusion. Afterwards, the resultant mixture was injected into a 4.3 micron cell which had unidirectionally rubbed polyimide alignment layers on the inner substrates in order to achieve both a standing helix in the absence of a field and a planar-aligned nematic in the field ‘on’ state. To apply an electric field to the sample perpendicular to the helix axis, indium tin oxide (ITO) was coated onto the surfaces to provide inter-digitated electrodes. The electrode spacing was 9 microns.

All measurements were carried out at a constant temperature of 25° C. A uniform alignment of chiral nematic liquid crystal was confirmed using an optical polarising microscope (BH-2, Olympus). An electric field was applied using a signal generator (TG1304, Thurlby Thandar) and a high voltage amplifier (built in-house). Transmission-voltage curves and the optical response were captured using a fast photodiode mounted in the phototube of the microscope and connected to a digitising oscilloscope. Photographs of the cells were captured using a Cannon Ixus-700 camera and a white light source (OSL1-EC illuminator, Thorlab Inc).

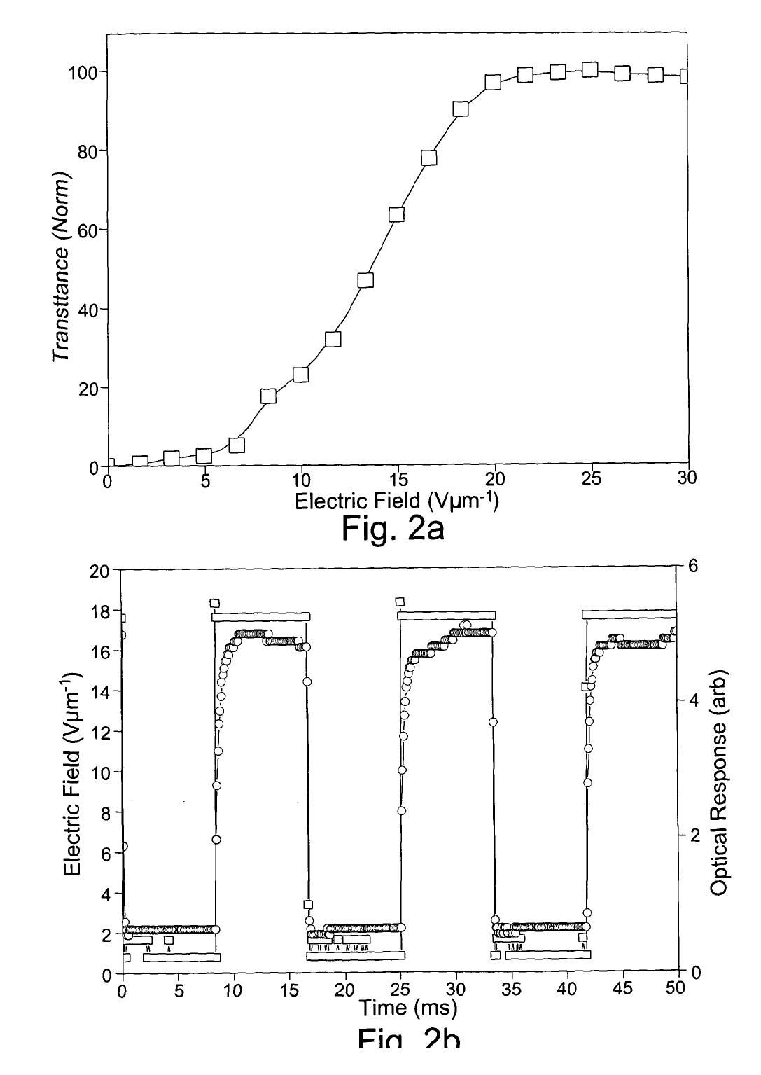

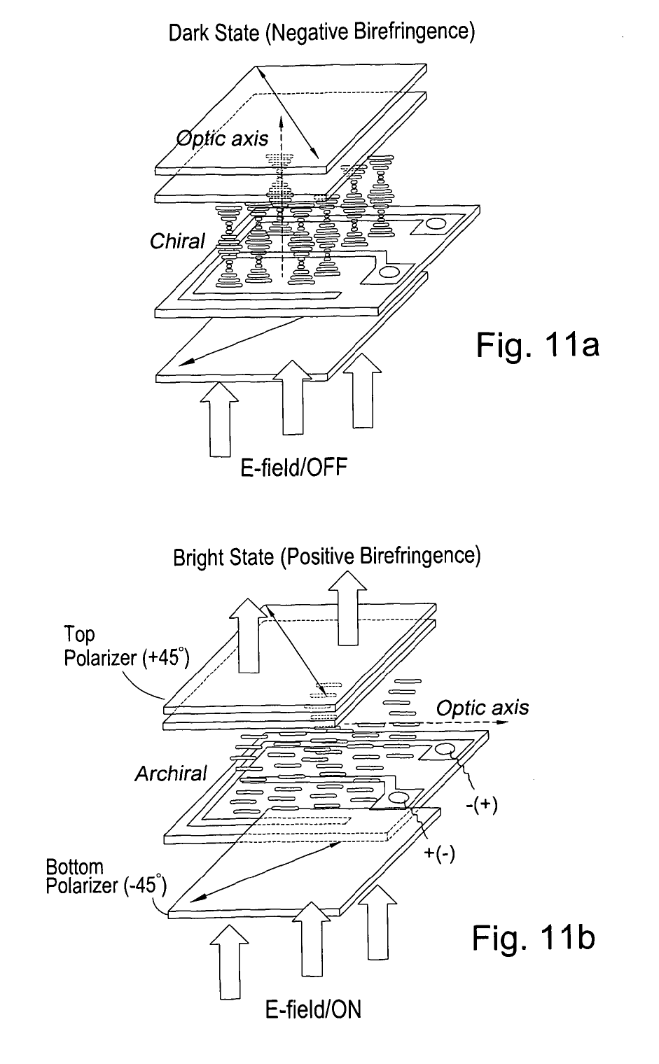

A schematic of the device including an illustration of the principle of operation is shown in FIG. 1. Experimental results of the transmission of the device as a function of the applied electric field, as well as the optical response demonstrating the rise and decay times, are shown in FIG. 2. The change in transmittance through the device increases as the strength of the field is increased with a threshold at approximately 6 V/um. The transmittance then increases with field strength up to 20 V/um at which point the transmittance saturates. The rather high threshold and saturation voltages in this experimental example may be a consequence of a very short pitch and a moderately low negative dielectric anisotropy. The short pitch indicates that a large electric field energy is advantageous to effect the switching by rotation and/or to overcome the twisting energy of the helix (for example where unwinding occurs as in FIG. 11, alternatively or in addition to rotation of the helical axis) whereas the low negative dielectric anisotropy implies that the coupling between the field and the LC is quite small. The response, on the other hand, is very short and is evident both from the rise and the decay times. FIG. 2b shows the optical response of the LC, plotted on the secondary axis, to a square wave with electric fields from 0 V/um to 18 V/um which is plotted on the primary axis. From this, the rise and decay times are found to be 1 ms and 100 us, respectively. The rise time is dependent upon the field strength whereas the decay time is found to be independent of the field strength. The rise time may be short by virtue of the fact that the dielectric coupling is quadratic in the field. The short decay time, on the other hand, is due to the very short pitch of the helix. Using hydrodynamic considerations it is possible to show that the response is quadratic in the pitch.

Photographs of a 4.3 micron-thick cell with in-plane electrodes between crossed polarisers and mounted on a light box are presented for different electric field strengths in FIG. 3. It can be seen that the cell is optically black and there is no discernible difference between the cell and the regions of crossed polarisers only. As the field strength is increased the sample becomes more and more transmissive as the helical structure rotates. There is a small amount of transmission at 3.3 V/um close to the threshold and increases dramatically until it reaches saturation. The maximum brightness is shown at a field strength of 16.7 V/um. The device may thus advantageously combine grey scale with short response times.

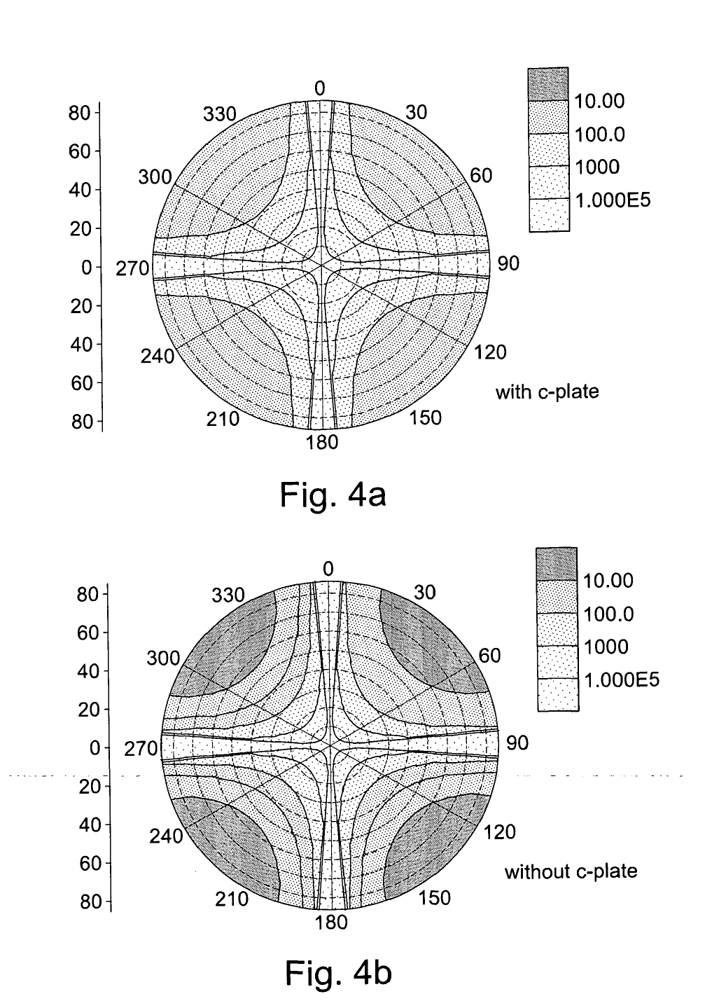

Using the Berremann 4×4 matrix, the isocontrast curves were calculated for the device with and without a compensation plate, FIG. 4. These results were obtained for a cell thickness of 4.3 microns, an incident wavelength of 550 nm and a birefringence of Δn=λ/(2d) (=0.064). In the field ‘off’ state the influence of wavelength is negligible, however, for the field ‘on’ state there is a wavelength dependence due to dispersion. At normal incidence the contrast ratio is at least ˜1000:1 and even as large as 65000:1 which is extremely high and is a consequence of the high extinction in the absence of an electric field due to the hyper twisted structure. Without the C-plate it is apparent that at oblique viewing angles the contrast is below 10:1 although this can be increased substantially when the C-plate is added. (An example of such a C-plate is a compensation plate in the form of an extra layer added after the liquid crystal layer and polarisers to increase viewing angles of displays).

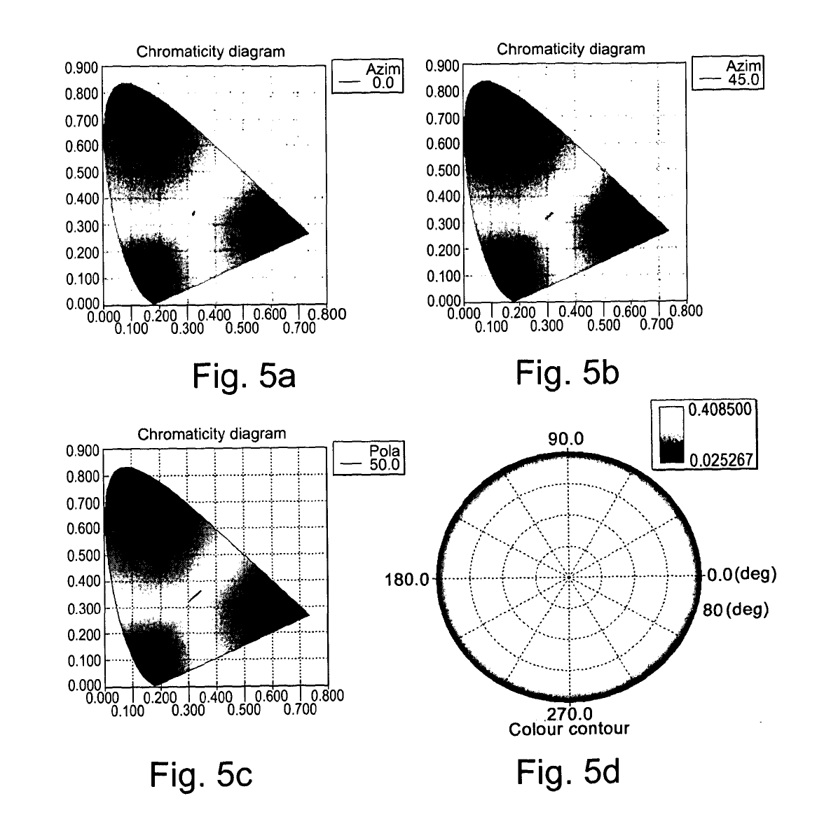

Finally, to examine the change in chromaticity as the viewing angle is varied, CIE diagrams are shown in FIG. 5. Three diagrams are shown corresponding to different polar and azimuthal angles and one diagram showing the colour contour. Each one was obtained using the Berreman 4×4 matrix and Standard Illuminant C. Here we assume that the field is applied linearly and uniformly and that there is no degree of chirality present. It is also assumed that there is no pretilt of the molecules at the surfaces of the substrates at both the light source and observer side. The first diagram (FIG. 5a) is for a fixed polar angle of 50° and the azimuthal angle is then varied from 0 to 360°. In this case it is predicted that there is almost no change in the chromaticity as the azimuthal angle is rotated from 0 to 360°. FIGS. 5b and 5c are for fixed azimuthal angles of 0 and 45°, respectively, and the polar angle is varied from 0 to 80°. An azimuthal angle of 0° corresponds to the polariser direction whereas an azimuthal angle of 45° corresponds to the optical axis in the field ‘on’ state. It is shown that there is a slight change in the chromaticity as the polar angle varies when the azimuthal angle is fixed at 45° (FIG. 5c). However, as demonstrated in the colour contour plot in FIG. 5d the variation in chromaticity is very small except for some slight ‘yellowing’ at the extremes.

In conclusion, the embodiment may advantageously demonstrate a fast-switching liquid crystal display mode with response times of 100 us and contrast ratios of at least ˜1000:1 and even as high as 65000:1 at normal incidence. Due to a continual reorientation of the LC molecules, transmission voltage curves show that the response may advantageously allow for greyscale controllability.

While the foregoing paragraphs relating to embodiments have considered entirely LC with negative dielectric anisotropy, we further disclose a device differing from the above LC device (and having any combination of one or more of the above optional features) only by having zero dielectric anisotropy.

The following describes a device and other arrangements and related methods, which use liquid crystal having positive dielectric anisotropy. (Though other arrangements may differ merely by substituting the positive anisotropic LC for zero dielectric anisotropy LC). Where the LC is provided in a composition further comprising a polymer (for example by adding reactive mesogen) as may be the case in any positive dielectric device/arrangement/method described herein, the polymer may be in the form of monoacrylate or diacrylate, this relating to the end groups that cross-link.

The liquid crystal device is for controlling outputting of light from said device, and comprises: chiral nematic liquid crystal having a helical arrangement of liquid crystal molecules and having positive dielectric anisotropy; at least two electrodes for applying an electric field having a component normal to the helical axis of the chiral nematic liquid crystal molecules, the chiral nematic having short (<380 nm) or long (>=380 nm) pitch. In such a device, the helical arrangement of molecules rotates to align to the local electric field, i.e., the field directly influencing the orientation of the molecules. Preferably, the at least two electrodes are in a substantially common plane, e.g., are in-plane electrodes.

A related method is of controlling output of light from a liquid crystal device, the device comprising chiral nematic liquid crystal having a helical arrangement of liquid crystal molecules and having positive dielectric anisotropy and further comprising at least two electrodes for applying an electric field normal to the helical axis of the chiral nematic liquid crystal molecules, the method comprising: applying the electric field; and rotating the helical arrangement to align with the electric field. Thus, as for all embodiments described in this specification, the helical arrangement may rotate to align to the local electric field, i.e., the field existing locally to the molecules of the helical arrangement or which may be uniform over the entire LC. The helical arrangement that exists in the absence of any electric field is referred to as a zero-field arrangement. Preferably the electric field local to the helical arrangement is normal to the orientation of the helical axis of the zero-field arrangement.

The light outputted by the device may be received by the device from an external source (e.g., sunlight, an external fluorescent source, LED, etc.) or may be generated internally, e.g., where light emitters are added to the LC to form, e.g., a laser. Whether the light source is internal or external, the above control may be of the proportion of generated light that forms the output light, and/or of the direction of transmission of the output light.

Advantageously, the helical arrangement of the chiral nematic (i.e., cholesteric) LC may rotate to become aligned with the electric field. Thus, the optical axis of the chiral nematic LC may reorient to align in the plane of the electrodes when the electric field is applied. The alignment may be full, for example where the device is used as a binary device. However, where the device is used in an analogue manner, e.g., for gray-scale, the LC may be controlled to rotate towards partial, i.e., incomplete, alignment with the electric field, depending for example on the strength of the electric field.

The rotation may occur without the LC helical arrangement unwinding. Furthermore, the device may be operable by application of the electric field to substantially fully align the helical arrangement with the electric field in less than about 50 ms, preferably less than about 10 ms, preferably less than about 1 ms.

(Other arrangements may differ from the or each of the aspects and embodiments described herein by the zero-field helical arrangement unwinding as shown in FIG. 11, alternatively or additionally to the rotation to align to the electric field).

As indicated above, for any of the positive dielectric anisotropy devices/methods described herein, the pitch of the helical arrangement may be short or long. A short pitch is a pitch that is shorter than the wavelength of visible light. Preferably, the pitch is less than 380 nm, more preferably less than about 260 nm, e.g., about 150 nm. However, the specific value of the pitch preferred for a given positive dielectric anisotropy embodiment may be greater than or less than 380 nm and/or may depend on the LC birefringence. Nevertheless, in any positive dielectric anisotropy embodiment, the liquid crystal is preferably short pitch liquid crystal.

Advantageously, the pitch may be such that the transmission of light through the LC is at least partially, preferably substantially fully, blocked in the absence of the electric field. Such an embodiment may comprise a polariser at least on a light input side of the device. Alternatively, the device may comprise polarisers on opposite sides of the LC, these polarisers having substantially perpendicular transmission axes. The blocking may be of at least about 95%, preferably about 100%, of polarised light incident on the input side of the LC. When the electric field is present, the LC preferably substantially fully transmits the light, e.g., transmits at least about 95% of the light.

Concerning more generally the above polarisers, the liquid crystal device may comprise at least two polarisers each having a polarisation axis (i.e., transmission axis), the polarisers comprising a pair that are aligned such that their axes are substantially perpendicular to each other (i.e. the polarisers are crossed), the chiral nematic LC being disposed between these two polarisers. (Alternatively, the pair may have their axes substantially parallel to each other. However, crossed polarisers is preferable, and in this case, the optical axis of the LC in the absence of the electric field may be at an angle of substantially 45 degrees to the polarisation axis of each said crossed polariser). The polarisers may be disposed on respective substrates of the device.

Thus, the device may be operable by the application of the electric field to have a ratio of transmission of the light (preferably polarised; internally or externally generated) in the presence of the electric field to transmission of the polarised light in the absence of the electric field of at least about 1000:1, preferably higher, e.g., at least about 6000:1.

The light controlled by the device may be polarised light, for example light that is input into the device from a polariser on one side of the LC.

There may further be provided the above device, wherein the LC helical arrangement, which may be short- or long-pitched, is stabilised by polymer. The liquid crystal may be comprised in a polymer composition, the polymer advantageously providing some elasticity to the LC. Such elasticity may make the LC more rugged, e.g., less susceptible to permanent damage when the LC is compressed, e.g., by pressing by a device user's finger. The elasticity may reduce hysteresis in the switching characteristic of the LC device, so that the switching time (i.e., time for alignment/de-alignment) is changed. Advantageously the time of de-alignment of the LC (i.e., for rotation of the LC helix to return to its original orientation, i.e., the orientation before the electric field was applied) is reduced due to the spring-like action of the polymer.

Further in this regard, the LC advantageously comprises dual frequency chiral nematic LC. In this case, the dielectric anisotropy changes sign with the frequency of the applied field. This may be advantageous to ensure that the LC helical arrangement rotates to return to the original position when the electric field is removed, i.e., rotates reversibly. The dual frequency LC may for example have a negative dielectric anisotropy within a frequency range, e.g., 100 Hz-1 kHz, and positive dielectric in another frequency range, e.g., above 1 kHz. Preferably, the frequency at which the dielectric anisotropy changes sign is less than about 100 kHz. Thus, the alignment of the LC helical axis may be recovered by application of a further electric field in a different frequency range. Dual frequency chiral nematic LC may be advantageous for example where the LC is not polymer-stabilised. (In others of the embodiments using the liquid crystal having positive dielectric anisotropy, the LC may be comprised in a composition having a low concentration of reactive mesogen (e.g., Merck RM-257) or polymer, for example as described herein in relation to embodiments using LC having negative dielectric anisotropy).

Where the LC does not comprise such dual frequency LC, the LC device may nevertheless be advantageous for, e.g., aligning a ULH (uniform lying helix), since such alignment of the LC helical arrangement may be stable in zero electric field even after rotation has occurred to align the helix to an applied electric field. Hence, in an arrangement there is provided a ULH comprising the liquid crystal device.

The above polymer composition may be achieved by adding to the LC a low concentration of polymer or of reactive mesogen (e.g., Merck RM257); which cross-links to form polymer. The concentration of added mesogen or polymer is preferably <20% w/w (weight by weight) relative to the LC.

Preferably the electrodes are configured to apply the electric field substantially fully normal to the zero-field helical axis of the LC.

The electrodes may comprise at least two electrodes on the same surface e.g., top or bottom surface, of the LC or on a surface of a substrate subsequently brought into direct or indirect contact with the LC. Such sets of electrodes may be found on two or more respective surfaces, e.g., first and second sets on the lower and upper surfaces of the LC, respectively. Moreover, any such set of electrodes may advantageously be configured to generate a fringe field.

The electrodes for applying an electric field may comprise electrodes on opposite sides of the LC, e.g., on the top and bottom of the LC or on substrates adjacent respective opposite sides of the LC. For example, first and second sets of electrodes on respective surfaces may be provided to apply respective electric fields that each have a component normal to the helical axis.

The electrodes of the LC device may comprise interdigitated electrodes on one side of the LC, e.g., on a substrate attached directly or indirectly to an upper or lower surface of the LC. The interdigitated electrodes may be separated from the substrate by an insulating layer. The electrodes may comprise finger-patterned electrodes on a layer and a plane electrode on another layer separated by an insulating layer (e.g., barrier layer) in the substrate.

The LC of the device may comprise one or more dyes, which may be absorptive or reflective dyes. More specifically, the dye(s) may be dichroic dye, pleochroic fluorescent dye, and/or a plurality of different coloured dyes, e.g., red, yellow and blue. Moreover, the above chiral nematic LC rotation to align with the electric field may further cause the dye molecules to rotate. Advantageously, this effect of the dyes within the device may effectively be switched on/off, by means of a dye-guest host effect. As a result, the provision of the single or at least two polarisers as described above may then be less advantageous.

The LC device may be a reflective device. In this case, external light (e.g., sunlight) may be received through one surface of the LC and reflected by a reflector attached (directly or indirectly) to an opposite surface of the LC. The LC device may comprise a reflective element that is, e.g., metallic, dielectric (e.g., a dielectric mirror), coloured, absorbing and/or fluorescent. A coloured or absorbing reflective element may selectively reflect different colours/wavelengths. The reflective LC device may be provided with a single, or no, polariser.

In a further arrangement, there is provided a display device comprising a plurality of the LC devices having positive dielectric anisotropy, which preferably include any combination of the above optional features. Such a display device may comprise a optical compensation film, which may widen the viewing angle of the display device by dispersing or diffusing the light output from the LC devices. The plate may—additionally or alternatively to being a compensation plate—be a diffusing plate. The diffusing and/or compensation plate may diffuse and/or phase retard light. Preferably, the range of viewing angles over which the image will be of good quality is increased by use of such a plate, even in embodiments where the light comes out at substantially all angles, e.g., over a full 180 degrees from a planar output surface of the device.

In a further arrangement, there is provided an optical waveguide device, e.g., for optical computing, telecommunication or data communication, comprising at least one of the LC devices having positive dielectric anisotropy, the LC device preferably including any one or combination of the above optional features.

In a further arrangement, there is provided a variable optical attenuator, an optical switch (e.g., for a wavelength division multiplexing (WDM) system and/or for blocking or passing WDM or single wavelength signals) or a light shutter, comprising at least one of the LC devices having positive dielectric anisotropy, the LC device preferably including any one or a combination of the above optional features.

In a further arrangement, there is provided a liquid crystal laser device comprising at least one LC device of the first arrangement, the LC device preferably including any one or combination of the above optional features. Preferably, the chiral nematic liquid crystal is doped with a light emitter or light harvester. The emitter or harvester may be a laser dye (this may be provided in liquid form, e.g. laser dye molecules in a solution and/or may be chemically attached to LC molecule), rare earth element(s), fluorescent dye and/or quantum dots. Advantageously, the laser device is for reorienting the direction and/or degree of transmission of a light beam output from the laser device. Regarding a detailed positive dielectric arrangement, there may be a device comprising long-pitch chiral nematic liquid crystal with no polymer with in-plane electric fields, for example for formation of a uniform lying helix (ULH). More particularly, the device may be a switchable liquid crystal element, either a display or phase modulation device, based upon the uniform lying helix (ULH) geometry in chiral nematic liquid crystals. The ULH is an in-plane alignment of the chiral nematic liquid crystal helical axis.

Typically, the ULH has previously been aligned by a complex and non-systematic combination of mechanical shearing, temperature ramping and electric fields. Induction of the ULH therefore requires some individual expertise and does not lend itself to mass production. A very surprising result has been the observation of the induction of the uniform lying helix (ULH) by in-plane electric fields. This technique also appears to offer increased stability of the induced texture e.g. the ULH is preserved on a much longer timescale without an external field applied. Traditionally seen in these experiments, the texture decays rapidly (order of seconds to minutes) to the Grandjean/focal conic state.

Although the electrical induction of the ULH is surprising, this observation may not always be sufficient to generate a switchable device (e.g. phase modulator or display). A further preferable feature is the incorporation of a third, plane-parallel electrode above the in-plane substrate. The device is formed as follows: the ULH is induced by the in-plane electric field; the field then is removed and the in-plane electrodes shorted (same potential). The device is then addressed by applying a voltage between the upper electrode and the (now common) substrate electrodes.

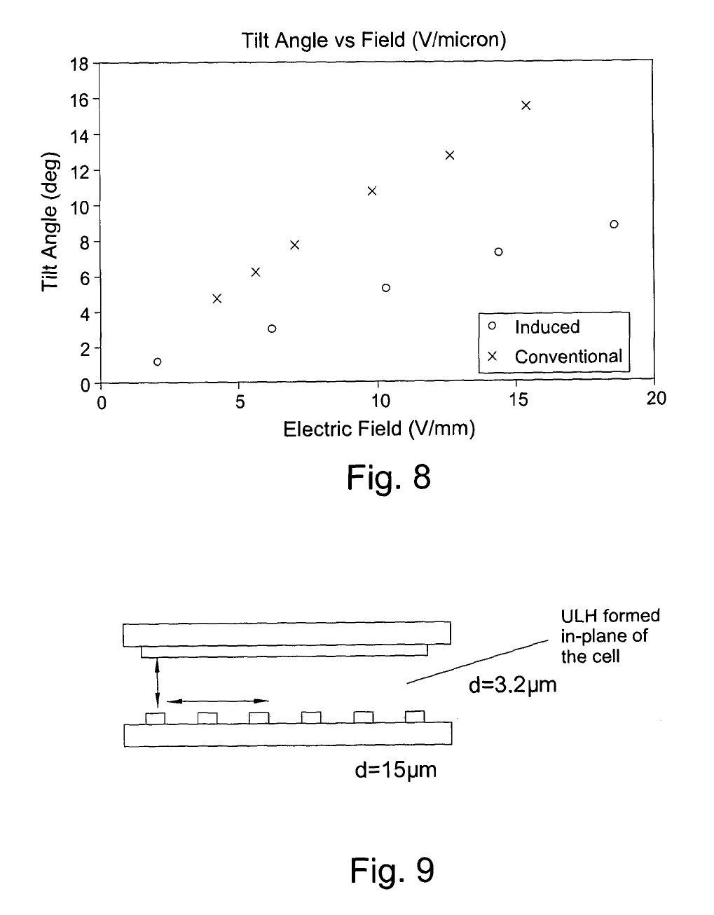

The graph of FIG. 8 shows the data for the all-electrical induced ULH device versus conventional (manual) induction. Although the tilt angle is reduced, the material used in the investigation possess only modest flexoelectric and/or dielectric coupling, which may govern the response. Using new materials, designed for improved flexoelectric and/or dielectric coupling, switching voltages of the order of several V/μm are possible for a typical cell thickness of 3-5 μm. A schematic of the device is shown in FIG. 9.

Potential advantages of the device may include a reproducible and electrically automated induction of the ULH texture. Furthermore, the ULH device, once formed, may permit fast switching (down to 10 μs), low voltage (conventional circuitry can be used), analogue (grey-scale) operation and/or phase modulation applications.

Regarding a further detailed positive dielectric arrangement, there may be a short-pitch chiral nematic liquid crystal with polymer with in-plane electric fields, for example for a fast-switching modulation device. Such a device may be a display device using a polymer stabilised short pitch chiral nematic liquid crystal with a large positive dielectric anisotropy. The display can be switched between an optically extinct ‘Off’ state to a bright ‘On’ state by the action of an external electric field and return to the optically extinct state after removal of the applied field. The device may possess excellent contrast and response times of the order of several milliseconds for On and sub-milliseconds for Off.

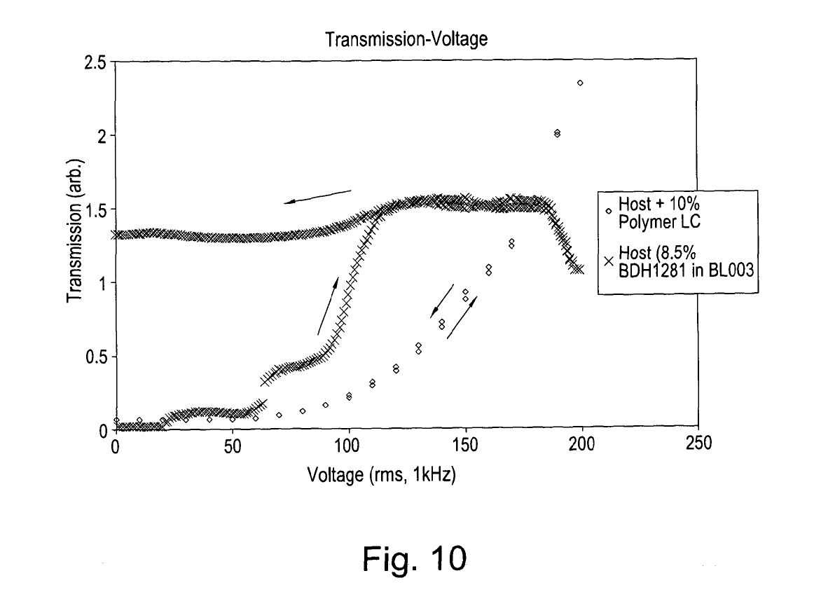

The graph of FIG. 10 shows the effect of polymer stabilising a short pitch material. The material is addressed by an in-plane field and is positioned between crossed polarisers. In this device, the voltage is ramped from 0V to 200V then back down to 0V to investigate the hysteresis properties. From the graph, for the non-polymer stabilised material, the device does not recover to the original (unswitched) state and therefore cannot be used as a display device. However, when the material comprises a reactive liquid crystal compound and is suitably UV polymerised, the device formed allows excellent recovery of the original unswitched state with minimal hysteresis. This is a surprising result and allows a device to be formed with very good contrast and fast response times e.g. On time of 5 ms and Off time of 0.2 ms, or On time of 0.5 ms and Off time of 0.2 ms. In yet more advantageous embodiments, response times of the order of 100 us for on and off have been achieved.

Potential advantages of the device may include: short pitch material allows an optically extinct Off state which permits excellent contrast; positive dielectric coupling (allows use of existing materials to significantly lower operating voltages); in-plane switch technology; and/or fast response.

Regarding all of the embodiments and arrangements above, no doubt many other effective alternatives will occur to the skilled person. It will be understood that the invention is not limited to the described embodiments and encompasses modifications apparent to those skilled in the art lying within the spirit and scope of the claims appended hereto.

1-67. (canceled)

68. A liquid crystal device for controlling transmission of polarised light, comprising:
chiral nematic liquid crystal having a helical arrangement of liquid crystal molecules in the absence of an electric field; and
at least two electrodes for applying an electric field having a component normal to the helical axis of the chiral nematic liquid crystal,
wherein the chiral nematic liquid crystal has negative dielectric anisotropy.

69. A liquid crystal device for controlling transmission of light, comprising:
a light source to emit said light;
chiral nematic liquid crystal having a helical arrangement of liquid crystal molecules in the absence of an electric field; and
at least two electrodes for applying an electric field having a component normal to the helical axis of the chiral nematic liquid crystal,
wherein the chiral nematic liquid crystal has negative dielectric anisotropy and is liquid crystal having pitch shorter than a shortest wavelength of said light.

70. A liquid crystal device for controlling outputting of light from said device, the device comprising:
chiral nematic liquid crystal having a helical arrangement of liquid crystal molecules and having positive dielectric anisotropy;
at least two electrodes for applying an electric field having a component normal to the helical axis of the chiral nematic liquid crystal molecules, the chiral nematic preferably having pitch shorter than a shortest wavelength of said light;
the liquid crystal such that the helical arrangement of molecules rotates towards alignment with the electric field, preferably to align with the local electric field,
wherein the liquid crystal is provided in a composition further comprising polymer.

71. A liquid crystal device for controlling output of light from the device, the device comprising chiral nematic liquid crystal having a helical arrangement of liquid crystal molecules and having positive dielectric anisotropy and further comprising at least two electrodes for applying an electric field normal to the helical axis of the chiral nematic liquid crystal molecules, the device comprising:
the liquid crystal such that, in the absence of the electric field, the orientation of the helical arrangement and optic axis of the chiral liquid crystal is such that the polarisation state of any linearly polarised light incident on the device is perpendicular to the optic axis and helical arrangement, and
the liquid crystal comprised in a composition having polymer, the polymer preferably being to a concentration of between about 0.1% and about 30% w/w in the host chiral liquid crystal;
the liquid crystal such that application of the electric field rotates the helical arrangement and optical axis of the chiral nematic liquid crystal to align, or partially align, to a plane defined by the electrodes;
the liquid crystal such that, after removal of the electric field, the optical axis and helical arrangement relax back to the state before the electric field was applied.

72. A liquid crystal device according to claim 68, wherein said chiral nematic liquid crystal molecules are helically arranged in the presence of said electric field, a helical axis of said arrangement in said presence of said field being aligned to said electric field applied to said molecules.

73. A liquid crystal device according to claim 68, wherein said liquid crystal helical arrangement is to dielectrically couple to the electric field to rotate the helical axis of said helical arrangement in a direction dependent on the direction of the electric field.

74. A liquid crystal device according to claim 68, configured such that an optic axis of the chiral nematic liquid crystal rotates in a plane normal to the electric field component when the electric field is applied, the rotation preferably to align the optic axis at least partially to the electric field.

75. The liquid crystal device according to claim 68, wherein said at least two electrodes are configured to apply said electric field substantially fully normal to the helical axis of the chiral nematic liquid crystal.

76. The liquid crystal device according to claim 68, further comprising a light source to emit said light to be controlled, wherein the liquid crystal has helical pitch shorter than a shortest wavelength of the emitted light, preferably shorter than about 380 nm.

77. The liquid crystal device according to claim 68, wherein the helical arrangement has a pitch such that transmission of said polarised light through said chiral nematic liquid crystal is substantially fully blocked in the absence of said electric field component.

78. The liquid crystal device of claim 77, wherein said substantially full blocking blocks at least about 95% of the polarised light.

79. The liquid crystal device according to claim 68, wherein the pitch is less than 380 nm, preferably less than about 260 nm, more preferably less than about 150 nm.

80. The liquid crystal device according to claim 68, wherein the chiral nematic liquid crystal has a thickness such that said polarised light is substantially fully transmitted though said chiral nematic liquid crystal in the presence of said electric field.

81. The liquid crystal device according to claim 68, configured to be operable by said application of said electric field to have a ratio of transmission of said polarised light in the presence of the electric field to transmission of said polarised light in the absence of the electric field of greater than about 1000:1, preferably greater than about 6000:1.

82. The liquid crystal device according to claim 68, configured to be operable by said application of said electric field to substantially fully align said helical arrangement to said electric field component in less than about 50 ms, preferably less than about 1 ms.

83. The liquid crystal device of according to claim 68, configured to be operable by removal of said applied electric field to substantially fully recover alignment of said helical arrangement in less than about 50 ms, preferably less than about 100 us.

84. The liquid crystal device according to claim 68, further comprising:
at least two polarisers each having a polarisation axis, wherein said two polarisers are crossed polarisers; and
said chiral nematic liquid crystal is disposed between said crossed polarisers.

85. The liquid crystal device according to claim 68, wherein the liquid crystal is comprised in a composition having polymer for stabilisation of molecular arrangements of the liquid crystal, preferably to reduce a switching response time of the device.

86. The liquid crystal device according to claim 68, wherein the chiral nematic liquid crystal comprises dye such as dichroic dye, pleochroic fluorescent dye and/or a plurality of different coloured dyes.

87. The liquid crystal device according to claim 68, having a composition comprising said chiral nematic liquid crystal and polymer.

88. The liquid crystal device according to claim 68, comprising at least one reflector, wherein said at least one reflector is preferably metallic, dielectric, colour, absorbing and/or fluorescent.

89. The liquid crystal device according to claim 68, wherein the at least two electrodes are in a substantially common plane.

90. The liquid crystal device according to claim 68, wherein the liquid crystal is to dielectrically couple to the electric field to rotate the helical arrangement of molecules towards alignment with the electric field.

91. Method of controlling outputting of light from a liquid crystal device, comprising:
applying an electric field to a helical arrangement of liquid crystal molecules of chiral nematic liquid crystal of said device; and
said helical arrangement rotating to align the helical axis of the arrangement to said electric field,
wherein said chiral nematic liquid crystal has negative dielectric anisotropy and said helical arrangement has helical pitch of less than 380 nm.

92. Method of claim 91, wherein said liquid crystal helical arrangement dielectrically couples to the electric field to rotate the helical axis of said helical arrangement in a direction dependent on the direction of the electric field, preferably wherein rotation is uniform.

93. Method of claim 91, further comprising removing said electric field to return the helical axis orientation to the orientation that existed before said applying said electric field.

94. Method of claim 91, wherein the electric field is applied by applying a potential difference to at least two electrodes in a substantially common plane adjacent the liquid crystal.

95. Method of controlling transmission of polarised light as claimed in claim 91, wherein
said electric field has a component normal to the helical axis of the chiral nematic liquid crystal.
